(19) United States
(12) Patent Application Publication
(10) Pub. No.: US 2007/0012319 A1
(43) Pub. Date: Jan. 18, 2007

(54) Jaw exerciser

(76) Inventors: Sandra Frascati, Palisade, CO (US); Maria Frascati, Palisade, CO (US)

Correspondence Address: Edwin L. Hartz;Suite 115, 619 Main Street, Grand Junction, CO, 81501, US

(21) Appl. No.: 11/374,649

(22) Filed: Mar. 14, 2006

Related U.S. Application Data
(60) Provisional application No. 60/661,336, filed on Mar. 14, 2005.

(51) Int. Cl. A61C 5/14

(52) U.S. Cl. 128/861

(57) ABSTRACT

A muscle exercise device having a nose portion of two opposing elongated thin plates and a handle portion for moving the plates to help alleviate pain associated with a users temporomandibular joint.

### CROSS-REFERENCE TO RELATED APPLICATION

This application claims the benefit of U.S. Provisional Patent Application No. 60/661,336, filed Mar. 14, 2005, the disclosure of which is incorporated herein by this reference.

### TECHNICAL FIELD

This invention relates to devices for exercising the TMJ and more particularly to a passive, user hand-operated joint and attendant muscle exercise device.

### BACKGROUND OF THE INVENTION

There are apparatuses for exercising the temporomandibula joint (TMJ) and attendant muscles. However, these apparatuses are bulky, expensive and/or relatively complex. A non-exhaustive example includes a jaw exerciser having a body with curvilinear guide tracks which guide movement of a carriage is disclosed in U.S. Pat. No. 5,035,420 issued Jul. 30, 1991, to Reinier Beeuwkes, et al. This device is relatively bulky and expensive. Another jaw exercising device where the user works his or her jaws against resilient compressible and stretchable material is disclosed in U.S. Pat. No. 5,582,560, issued Dec. 10, 1996, to Gerald L. Magnuson. The compressible material form a pair of bite pads which have an upper surface and a lower surface that are engaged by the teeth on the opposite sides of the mouth arch. The resistance that the muscles work against is determined by and limited by the compressibility of the material used and cannot be controlled by the user. A third jaw-exercising device is disclosed in U.S. Pat. No. 5,846,212, issued Dec. 8, 1998, to Reinier Beeuwkes, et al. This device has three plates with two of them having a mouthpiece to engage either the teeth of the maxilla or the teeth of the mandible. The third plate is a control plate. This device is relatively complex in construction and operation.

### SUMMARY OF THE INVENTION

It is an object of the present invention to provide a simple to operate, relatively inexpensive device for exercising the temporomandibula joint and attendant muscles. The TMJ and muscle exerciser has two identical pieces joined at a pivot point and held in place by some holding means, such as a bolt and nut. The pivot point of each elongated piece is off center to provide a short portion and a long portion. The short portion has a thin rectangular box shape that goes into the mouth of the user. The short portion is thus the mouth end of the device. The long portion of the two elongated pieces form the handle of the device. The elongated pieces have a cylinder at the pivot point that extends across approximately one-half of the width of the elongated piece. Adjacent to the cylinder, in the remaining portion of the width of the elongated piece, is a concave surface that corresponds to the exterior surface of the cylinder on the adjoining elongated piece to permit movement of the cylinder in the concave surface in operation of the device.

The outside surface of the mouth end is slightly textured to provide a stable, non-slip contact with the users back molars when the device is in use. This device, unlike the apparatus discussed above, is designed to contact the back molars to give better leverage for stretching the jaw muscles.

### BRIEF DESCRIPTION OF THE DRAWINGS

FIG. 1 is a side-elevation view of the jaw exerciser device with the mouth end on the left, in accordance with the present invention;

FIG. 2 is perspective view of the two identical elongated parts and the attachment means, in accordance with the present invention; and

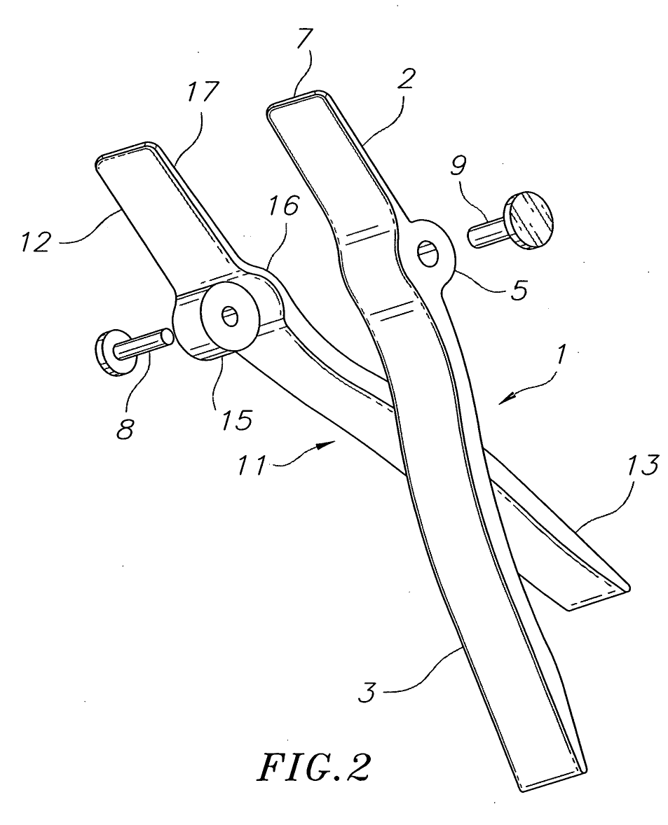

FIG. 3 is a perspective view of the device assembled, in accordance with the present invention.

### DESCRIPTION OF THE PREFERRED EMBODIMENT

The temporomandibula joint exerciser device has two identical elongated parts 1 and 11. These parts are preferably made from lightweight plastic, having sufficient strength and durability to exercise the jaws of a user. The device is relatively inexpensive to manufacture with the elongated pieces being molded plastic. However, these pieces may also be aluminum or some other lightweight and durable material that has the strength to withstand the pressures during the exercising of a persons jaw. The elongated pieces 1 and 11 are approximately 6 inches in length and ⅝ inches in width. The thickness of the elongated pieces is thin at the mouth end and thicker at the handle end.

Elongated piece 1 has a nose or mouth portion 2 and handle portion 3. The elongated piece also has a cylindrical portion 5 and a mating concave surface 6 that is not shown in the drawings. However, the mating concave surface 6 of elongated piece 1 is identical in configuration and position to the mating concave surface 16 of elongated piece 11.

The second elongated piece or part 11 has a nose or mouth portion 12, a handle portion 13, a cylindrical portion or cylinder 15 and a mating concave surface 16.

The cylinders 5 and 15 are off center, that is they are closer to one end of the elongated pieces 1 and 11, respectfully, than the other end. This results in the short portion, the mount ends 2 and 12, and a long portion, the handle ends 3 and 13.

The second and identical elongated piece 11 has its interior surface facing the interior surface of elongated piece 1 so that the cylindrical portion 5 of elongated piece 1 fits in and rides in the concave section or surface 16 of elongated piece 11. The cylinders, 5 and 15 of parts 1 and 11, are joined side-by-side and ride in the mating concave surface 16 and 6 of the opposing elongated part.

The centerline of cylinders 5 and 15 is perpendicular to the longitudinal axis of its respective part and extends across approximately one-half of the width from one edge. The mating concave surfaces 6 and 16 also extend across approximately one-half of the width from the edge opposite the cylinder.

The short portion or the mouth portion 2 of the elongated piece 1 has a shallow concave surface 7 on the exterior of the piece. Elongated piece 11 also has a nose or mouth portion 12 with a shallow concave section or surface 17.

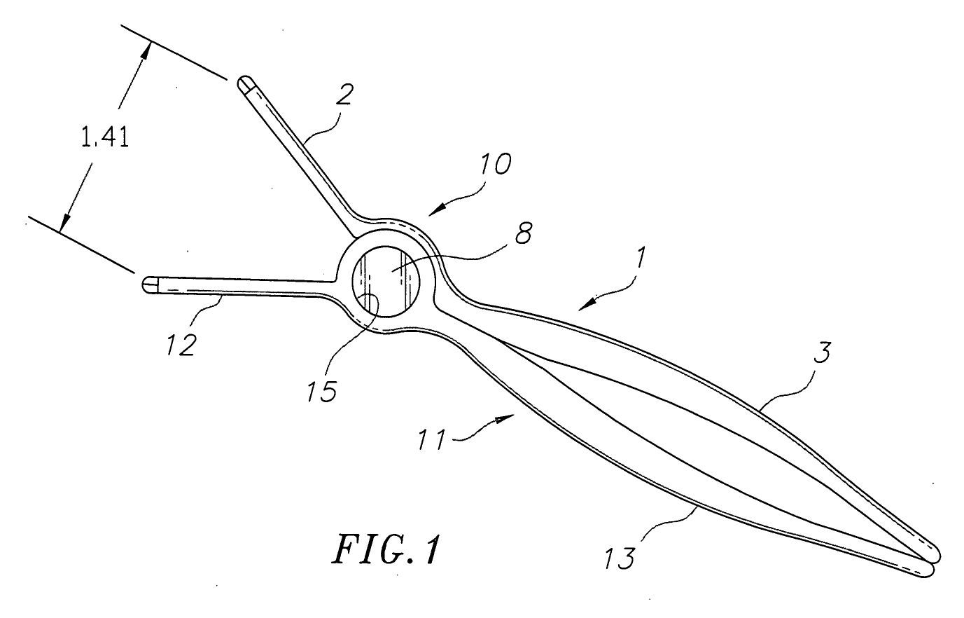

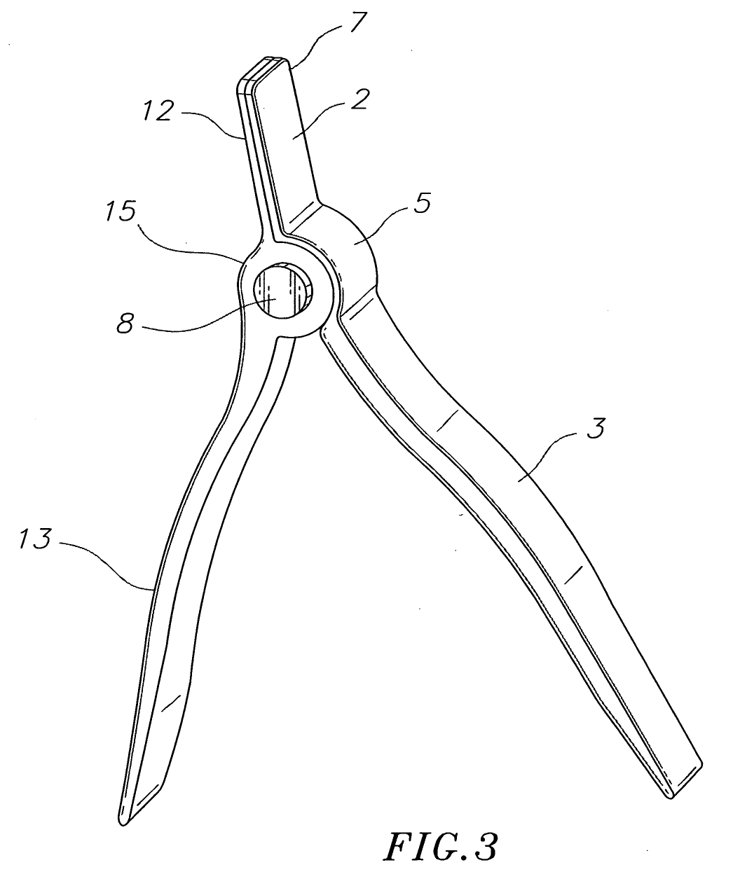

The long portion 13 of elongated piece 111 cooperates with the long portion 3 of elongated piece 1 to form the handles of the jaw-exercising device. When the cylinders 5 and 15 are placed side-by-side in the respective concave surfaces 6 and 16, the bolt 8 and nut 9 are inserted in the holes of the cylinders to hold the elongated pieces 1 and 11 together, as shown in FIGS. 1 and 3.

A pivot point or fulcrum 10 is along the centerlines of the cylinders 5 and 15. The distance between the center of the pivot point 10 and the end of each mouth portion 2 and 12 is approximately ⅖ the length from the center of the pivot point 10 to the ends of the handle portions 3 and 13. As a consequence, there is a resultant leverage of approximately 2½ to 1 between the handle end and the mouth end of the jaw-exercising device.

When the handles are open, as shown in FIG. 3, the mouth end of the device is closed and is easily inserted into the mouth of the user. The user then squeezes the handles 3 and 13 to force the mouth end open to exercise the TMJ and attendant muscles of the user.

A movement inwards of the handles 3 and 13 of 2½ centimeters, measured from the ends of the handles, results in separating or spreading the tips of the nose or mouth portion 2 and 12 by approximately 1 centimeter. (The size of the device is very close to the scale of the device shown in FIG. 1. The distance between the tips of mouth ends 2 and 12 of 1.41 in FIG. 1 is in inches.)

The opening of the mouth portion and the force used against the jaw is determined by the user. The mouth portion of the exercising device is placed between the molars on one side of the jaw so that the concave surfaces 7 and 17 contact the rear molars and provide a non-slip contact for the exercise device in use.

In usage, the user holds the passive jaw exerciser by the handles 3 and 13, in the closed position, FIG. 1. The mouth portion 2, 12 is placed between the molars on one side of the jaw, such that the concave surfaces 7, 17 conform to the rear molars providing a non-slip contact. The user gently presses the handles 3, 13 together with either hand to provide a gentle stretch of the muscles associated with the temporomandibula joint. The user acquiesces to this pressure by relaxing the jaw muscles. This process can be repeated on the other side of the jaw.

Ideally, the user performs this exercise at least twice a day for a period of at least two months in order to help alleviate stored tension and soreness in the jaw muscles. Before using the device, it is expected the user will consult with his or her dentist or other related certified health professional.

In summary, the invention described herein generally relates to an improved TMJ and muscle exercise device. While certain exemplary embodiments have been described above in detail and shown in the accompanying drawings, it is to be understood that such embodiments are merely illustrative of and not restrictive of the broad invention.

In view of the above, it will be understood that the invention is not limited to the particular embodiments or arrangements disclosed but is rather intended to cover any changes, adaptations or modifications which are within the scope and spirit of the invention as defined by the appended claims.

1. A muscle exercise device to help alleviate pain associated with a users temporomandibular joint comprising a first elongated part, the first part having a cylindrical portion closer to one of the ends of the part and forming a long portion and a short portion, the centerline of the cylinder being perpendicular to the longitudinal axis of the part, a concave surface adjacent to the cylindrical portion sharing the width of the part, a second elongated part identical in configuration to the first part and having its interior surface facing the interior surface of the first part and means to join the two parts together through the holes in the cylinders, thereby forming a pivot point for rotational movement of one part relative to the other part.

2. A device in accordance with claim 1, wherein the short portion of each part has a thin rectangular paddle with the length extending from the cylindrical portion to the end of the short portion for insertion in the user's mouth.

3. A device in accordance with claim 1, wherein the long portion of each part cooperate to form handles to be moved together and apart about the pivot point.

4. A device in accordance with claim 1, wherein the long portion has a selected length from the center of the pivot point to the end that is greater than the distance from center of the pivot point to the end of the short portion.

5. A device in accordance with claim 4, wherein the length of the long portion is 2½ times as long as the length of the short portion.

6. A muscle exercise device comprising two identical elongated parts, having an interior surface and an exterior surface, with the interior surfaces facing each other and means for joining the two parts at a pivot point, wherein the pivot point is closer to one end than the opposite end of the two parts.

7. A muscle exercise device comprising two identical elongated pieces joined at a pivot point, means for holding the pieces together at the pivot point, the pivot point of each elongated piece being off center to provide a short mouth portion and a long handle portion.

8. A device according to claim 7, wherein each short portion has a thin rectangular paddle shape.

9. A device according to claim 7, further comprising a cylindrical portion on each elongated piece at the pivot point.
